(19) United States
(12) Patent Application Publication
(10) Pub. No.: US 2021/0256461 A1
(43) Pub. Date: Aug. 19, 2021

(54) CONTROLLER FOR PRODUCT REPLENISHMENT, AND PRODUCT REPLENISHMENT SYSTEM

(71) Applicant: THK CO., LTD., Tokyo (JP)

(72) Inventor: Kaoru HOSHIDE, Minato-ku, Tokyo (JP)

(73) Assignee: THK CO., LTD., Tokyo (JP)

(21) Appl. No.: 17/056,503

(22) PCT Filed: May 14, 2019
(86) PCT No.: PCT/JP2019/019122

§ 371 Date: Nov. 18, 2020

(30) Foreign Application Priority Data
May 22, 2018 (JP) 2018-098288

(51) Int. Cl. G06Q 10/08; A47F 5/00; A47F 1/12

(52) U.S. Cl. CPC G06Q 10/087; A47F 1/125; A47F 5/0043

(57) ABSTRACT

A controller comprises a detecting unit which detects a fulfilled state of a product on a store shelf; a first control unit which issues an instruction for conveying the product required to fulfill the store shelf from a storage space to the store shelf on the basis of the fulfilled state; a second control unit which issues an instruction for moving to the store shelf on the basis of the fulfilled state; a third control unit which issues an instruction for allowing an arrangement area to slide from inside of the store shelf to the front of the store shelf so that the replenishing apparatus can access the arrangement area in which the product is arranged on the store shelf; and a fourth control unit which permits the replenishing apparatus to lift the product conveyed by the conveying apparatus and replenish the arrangement area slide frontward with the product.

### TECHNICAL FIELD

The present invention relates to a controller for controlling a product replenishment system including a replenishing apparatus and a conveying apparatus for replenishing a store shelf with a product, and the product replenishment system.

### BACKGROUND ART

In a store such as a supermarket, a convenience store and the like, store shelves are installed, on which a variety of products are displayed or exhibited. Then, a user (person who makes use of the store) picks up an intended product from the store shelf, and the user purchases the product. On this account, if the number of the products displayed on the store shelf is decreased or the product disappears from the store shelf, on account of the purchase of a certain product by the user, then it is necessary for the store to replenish the store shelf with the product. For example, Patent Literature 1 discloses a store shelf which has a structure to mitigate the load on an operator upon the replenishment with the product. In the case of this store shelf, when an inclined arrangement area for the product is drawn out frontwardly, a back end side thereof is moved downwardly. Therefore, the inclination of the arrangement area is relieved, and the force, which is exerted by the operator to support the arrangement area, is mitigated.

Further, in recent years, for example, in order to improve the convenience of the user, a variety of techniques have been developed, which relate to the automatic product sales system to be adopted in the store. For example, Patent Literature 2 discloses such a technique relevant to an automatic sales system to be adopted in a store that a code of a product desired to be purchased by a user is read by a reader, the product, which corresponds to the read code, is taken out from a store shelf (accommodating case), and then the product is conveyed to a product delivery machine. Further, in the case of the system described in Patent Literature 2, a product taking out apparatus, which is provided to take out the product from the store shelf, is installed in front of the store shelf. This product taking out apparatus is movable in the longitudinal direction and the lateral direction with respect to the store shelf, and the apparatus takes out the product designated by a host computer from the store shelf. Further, the product taking out apparatus also successively performs the replenishment with the product for the store shelf on the basis of an instruction from the host computer. In this procedure, the product taking out apparatus takes out the product from a shelf of a product replenishing case on which the product for the replenishment is placed, and the apparatus replenishes the store shelf with the product.

### PRIOR ART LITERATURES

### Patent Literatures

Patent Literature 1: Japanese Patent Application Laid-Open No. 2000-155869

Patent Literature 2: Japanese Patent Application Laid-Open No. 8-161406

### SUMMARY OF THE INVENTION

### Problems to be Solved by the Invention

As described above, it is necessary that the store shelf installed in the store should be replenished with the product at the appropriate timing. In recent years, such a demand rises that the store is managed more efficiently by suppressing the number of staffs to be put in position in the store. For example, it is possible to exemplify an unmanned store which is configured to enable the purchase of products without putting any clerk in position. However, even in the case of the unmanned store as described above, if the products are successively purchased, then the number of the products is eventually decreased on the store shelf, and it becomes necessary to replenish the store shelf with the product.

Further, from the viewpoint of the user, it is affirmed that the desire of the user to purchase the product is lowered if a state, in which the number of products displayed on the store shelf is small, is generated. On this account, those who participate in the store consider and intend the improvement in the product purchase result by responding to the desire of the user to purchase the product by timely replenishing the store shelf with the product, preferably by progressively replenishing the store shelf with the product in response to the sales of the product. However, if it is intended to realize the timely replenishment with the product as described above, then staffs for such a purpose are required, and the efficient store management, which is realized by suppressing the number of staffs, is inhibited.

The present invention has been made taking the foregoing problem into consideration, an object of which is to provide a technique that makes it possible to more preferably replenish a store shelf with a product.

### Means for Solving the Problems

In the present invention, in order to solve the problem as described above, the controller of the present invention is a device or an apparatus for controlling a product replenishment system including a store shelf, a conveying apparatus, and a replenishing apparatus. Then, if a state, in which the store shelf is to be replenished with a product, is detected, the controller issues predetermined operation instructions to the conveying apparatus and the replenishing apparatus respectively. Thus, the store shelf is preferably replenished with the product.

In particular, the present invention resides in a controller for product replenishment for controlling a product replenishment system including a store shelf on which one product or a plurality of products can be arranged; a conveying apparatus which is autonomously movable and which conveys a product for replenishing the store shelf therewith from a storage space for storing the product therein to the store shelf; and a replenishing apparatus which is autonomously movable and which lifts the product conveyed by the conveying apparatus and replenishes the store shelf with the product. Then, the controller for product replenishment comprises a detecting unit which detects a fulfilled state of the product on the store shelf; a first control unit which issues, to the conveying apparatus, an instruction for conveying the product required to fulfill the store shelf from the storage space to the store shelf on the basis of the fulfilled state detected by the detecting unit; a second control unit which issues, to the replenishing apparatus, an instruction for moving to the store shelf on the basis of the fulfilled state detected by the detecting unit; a third control unit which issues, to the store shelf, an instruction for allowing an arrangement area to slide from inside of the store shelf to the front of the store shelf so that the replenishing apparatus can access the arrangement area in which the product is arranged on the store shelf; and a fourth control unit which permits the replenishing apparatus to lift the product conveyed by the conveying apparatus and replenish the arrangement area slide frontward with the product.

### Advantageous Effect of the Invention

It is possible to more preferably replenish the store shelf with the product.

### BRIEF DESCRIPTION OF THE DRAWINGS

FIG. 1 shows a schematic arrangement of a store in which a product replenishment system according to an embodiment is arranged.

FIG. 2 shows a schematic structure of a store shelf.

FIG. 3 shows the operation of the store shelf.

FIG. 4 shows a schematic structure of a conveying apparatus.

FIG. 5 shows a schematic structure of a replenishing apparatus.

FIG. 6 shows a schematic structure of a guiding apparatus.

FIG. 7 shows the functional configuration of the product replenishment system according to the embodiment.

FIG. 8 shows the functional configuration of a server according to the embodiment.

FIG. 9 shows a flow chart for managing product purchase by a user.

FIG. 10 shows a flow chart for replenishing the store shelf with a product.

### EMBODIMENTS FOR CARRYING OUT THE INVENTION

A controller for product replenishment of the embodiment of the present invention (hereinafter simply referred to as “controller”) controls a product replenishment system comprising a store shelf on which a product or products is/are arranged, a conveying apparatus which conveys the product, and a replenishing apparatus which replenishes the store shelf with the product. In this case, the store shelf is not only such one that the product is arranged in the arrangement area thereof, but the store shelf is configured such that the arrangement area thereof slides from the inside of the store shelf to the front of the store shelf in accordance with the instruction issued from the third control unit, and the arrangement area protrudes to the outside of the store shelf. Owing to the configuration as described above, the arrangement area, which slides to the outside, can be accessed from the front of the store shelf. Note that the store shelf may be further configured such that the arrangement area, which slid outward, slides so that the arrangement area is accommodated in the inside of the store shelf again in accordance with the instruction from the controller.

Further, the conveying apparatus is such an apparatus that the product, with which the store shelf is to be replenished, is conveyed to the store shelf from the storage space such as a storehouse or the like. The conveying apparatus is configured to be autonomously movable. The phrase “autonomously movable” means that the conveying apparatus itself is configured to be capable of moving from the storage space to the store shelf without receiving any instruction relevant to the movement from the controller. That is, the word “autonomous” means the dependency from the controller in relation to the movement. Therefore, if a plurality of conveying apparatuses are included in the product replenishment system, a case, in which the plurality of conveying apparatuses move while cooperating with each other by performing the information interchange among the conveying apparatuses, can be also regarded as the autonomous movement. Further, similarly, the conveying apparatus may be also configured such that the information interchange is also performed with respect to the replenishing apparatus in relation to the movement so that the conveying apparatus moves in cooperation therewith. Note that it is enough that the conveying apparatus is configured to be at least autonomously movable. No problem arises even when the conveying apparatus is further configured such that the conveying apparatus can move in accordance with the instruction from the controller. Further, the controller is not prevented from performing a collecting process for collecting the information relevant to the conveying apparatus, for example, by chasing the position of the conveying apparatus which performs the movement.

Further, the replenishing apparatus is an apparatus configured such that the product, which is conveyed by the conveying apparatus, is lifted and the store shelf is replenished therewith. The replenishing apparatus is also configured to be autonomously movable. The phrase “autonomously movable”, which is referred to in relation to the replenishing apparatus, is substantially the same as that referred to in relation to the conveying apparatus. Any detailed explanation thereof is omitted. As for the replenishing apparatus, it is possible to adopt various configurations provided that the product can be lifted and the store shelf can be replenished therewith. For example, the replenishing apparatus may be a movable type robot including a movable member which is autonomously movable, an arm unit which is provided on the movable member and which has a plurality of arms connected at respective joints so that the plurality of arms are relatively displaceable with respect to one another, and a hand unit which is provided on a forward end side of the arm unit and which is capable of gripping the product. Further, it is also allowable to adopt such configuration that the product is lifted while sucking the product, in place of the hand unit for lifting the product.

In the product replenishment system configured as described above, the controller issues instructions to the store shelf, the conveying apparatus, and the replenishing apparatus respectively on the basis of the fulfilled state of the product detected by the detecting unit. Note that the fulfilled state of the product is the state which indicates the degree of arrangement of the product on the store shelf, and the fulfilled state of the product correlates with the necessity for execution of the replenishment of the store shelf with the product. Therefore, if it is judged that the necessity is confirmed for the replenishment with the product in accordance with the fulfilled state of the product, the first control unit and the second control unit issue the instructions to the conveying apparatus and the replenishing apparatus respectively. Note that the instruction to the conveying apparatus given by the first control unit and the instruction to the replenishing apparatus given by the second control unit may be issued on the basis of different criteria respectively, or they may be issued on the basis of an identical criterion. Then, the controller issues the instruction to the store shelf by the aid of the third control unit so that the arrangement area protrudes frontwardly. Note that the instruction given by the third control unit is preferably issued when the conveying apparatus and the replenishing apparatus are disposed closely to the store shelf so that the user or the like, who is present around the store shelf, is not disturbed. In the state in which the arrangement area is withdrawn frontwardly with respect to the store shelf in accordance with the instruction given by the third control unit, the replenishing apparatus easily accesses the arrangement area, and it is expected that the replenishing operation with the product may be efficiently performed.

Then, if the replenishment permission is issued by the fourth control unit to the replenishing apparatus, the replenishment with the product is executed by the replenishing apparatus for the arrangement area slide to the front of the store shelf. As described above, when the controller controls the product replenishment system by using the trigger of the fulfilled state of the product on the store shelf, then the replenishment with the product can be executed for the store shelf timely, and it is possible to establish such a state that the products are preferably aligned on the store shelf while suppressing the number of staffs.

A specified embodiment of the present invention will be explained below on the basis of the drawings. For example, the dimension or size, the material, the shape, and the relative arrangement of each of constitutive parts or components described in the embodiment of the present invention are not intended to limit the technical scope of the invention only thereto unless specifically noted.

### Embodiment

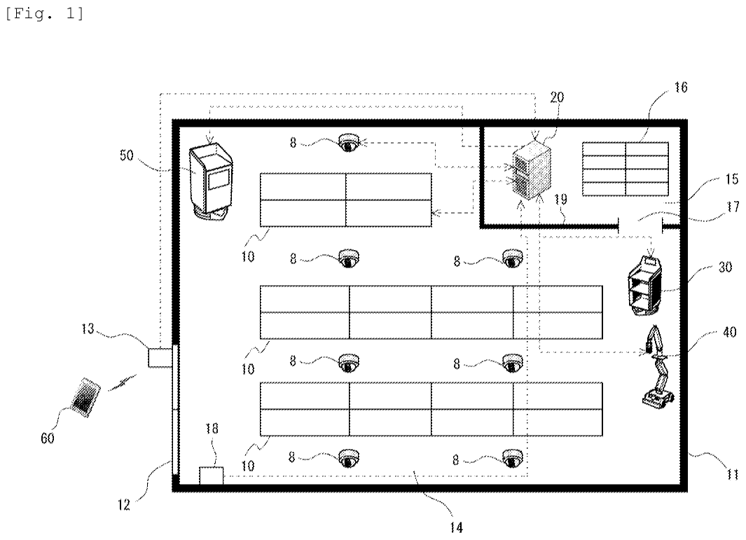

FIG. 1 shows a schematic arrangement of a store in which a controller according to the embodiment of the present invention and a product replenishment system including the controller are arranged. Note that FIG. 1 shows a state in which the store is overlooked from an upper position. The store is surrounded by walls 11 to form an inner space 14 in which products are selected and purchased by users. An entrance/exit 12 is provided at a part of the wall 11 in order to enter/exit the store. Note that the user is not permitted to freely enter the room of the store. Only the user, who is personally identified by a room entrance identification apparatus 13 arranged in the vicinity of the outer side of the entrance/exit 12, is permitted to enter the room, for whom the door of the entrance/exit 12 is opened. Note that as for the identification of the user performed by the room entrance identification apparatus 13, a predetermined identification process is executed between the room entrance identification apparatus 13 and a user terminal 60 carried by the user. However, details of the process will be described later on. Further, a room exit identification apparatus 18 is arranged in the vicinity of the inner side of the entrance/exit 12. The user, who intends to exit the room of the store, is identified thereby. Upon the room exit, an accounting process (charging process) is automatically executed for the product or products purchased by the user in the store. However, details of the process will be also described later on.

In this case, a plurality of arrays of store shelves 10, on which the products to be purchased by the user, are arranged in the inner space 14. In FIG. 1, the store shelf 10 is arranged so that the front thereof is opposed to the front of another store shelf 10, or the front thereof is opposed to the inner wall surface of the wall 11 for forming the inner space 14. Therefore, the user moves through a passage between the store shelf 10 and the store shelf 10 or a passage between the store shelf 10 and the inner wall surface of the wall 11 (these passages are referred to as “passages for movement”). The user moves to the store shelf 10 on which the product intended to be purchased by the user himself/herself is arranged. The user stretches his/her hand from the position disposed in front of the store shelf 10, and the user picks up the product. Then, recording cameras 8, each of which is provided to record, in a moving image, the action (access action) in relation to the access of the user to the product as described above, are arranged on the ceiling of the store. The plurality of recording cameras 8 are installed on the ceiling of the store so that the access action of the user is photographed or subjected to the image pickup without any blind spot, in the passages for movement and any other passages in the store.

Further, a backyard 15, which is a space distinct from the inner space 14, is formed by comparting a part of the inner space 14 by partition walls 19. The backyard 15 is also a storage space for storing the products scheduled to be sold to the user in the inner space 14, i.e., the products scheduled to replenish the store shelf 10 therewith so that the products are to be purchased by the user. The product, with which the store shelf 10 is scheduled to be replenished as described above, is referred to as “replenishing product”. Further, the replenishing products are accommodated and stored on a rack 16 in the backyard 15. An entrance/exit 17 is provided in order to enter/exit the backyard 15. However, in principle, the user is prohibited from entering the backyard 15.

Further, a server 20, which is the controller, is also arranged in the backyard 15. The server 20 is a computer having an arithmetic processing unit and a memory. The server 20 is electrically connected to the recording camera 8, the store shelf 10, the room entrance identification apparatus 13, and the room exit identification apparatus 18 described above, and the information can be mutually sent/received. Further, the server 20 is also electrically connected to a conveying apparatus 30, a replenishing apparatus 40, and a guiding apparatus 50 respectively, and the information can be mutually sent/received. The conveying apparatus 30 is an apparatus for conveying the replenishing product from the backyard 15 to the predetermined store shelf 10. The replenishing apparatus 40 is an apparatus for lifting the conveyed replenishing product and replenishing the predetermined store shelf 10 therewith. The guiding apparatus 50 is an apparatus for executing a predetermined guiding action in order to secure the safety during the replenishing operation performed by the replenishing apparatus 40. Details of these apparatuses will be described later on. As described above, the server 20 is electrically connected to the various constitutive components relevant to the purchase of the products in the store, and thus the server 20 configures a system relevant to the product management in the store. Note that the electric connection, which is referred to in the embodiment of the present invention, may be either the wired connection or the wireless connection.

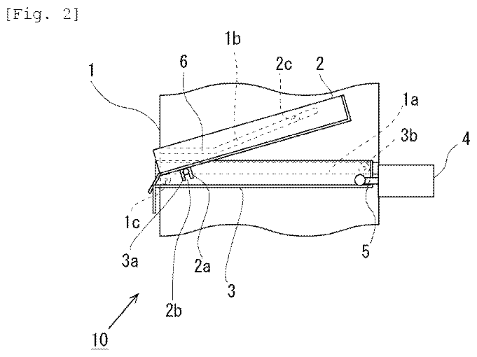

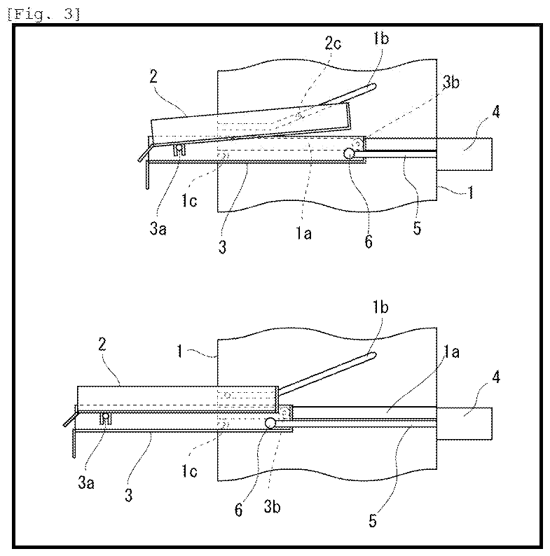

An explanation will now be made about the store shelf 10 on the basis of FIGS. 2 and 3. FIG. 2 shows the store shelf 10 in a state in which an arrangement area 2 for arranging the products is accommodated in the inside of the store shelf 10 (i.e., a state in which the user purchases the product), as viewed from a position disposed on the side of the store shelf 10. Further, FIG. 3 shows a state in which the arrangement area 2 of the store shelf 10 slides to the front of the store shelf 10 and protrudes to the outside of the store shelf 10, as viewed from a position disposed on the side of the store shelf 10.

The store shelf 10 is provided with a pair of side plates 1 which are disposed in the widthwise direction and which form a main apparatus body, the arrangement area 2 on which the products are placed, and slide members 3 which are supported by the respective side plates 1 movably in the front-back direction. The arrangement area 2 is supported tiltably in the upward-downward direction by the respective side plates 1 and the slide members 3. Each of the side plates 1 (only one of them is shown) has a first guide groove 1a for supporting the slide member 3, and a second guide groove 1b for supporting the arrangement area 2. The first guide groove 1a is formed linearly in the front-back direction. A roller 1c is attached on the front end side of the first guide groove 1a. Further, the second guide groove 1b has its front end side which is formed linearly in the front-back direction. The back end side of the second guide groove 1b is formed to be inclined downwardly toward the front.

The arrangement area 2 has engaging plates 2a which are engaged with the slide members 3 at both side portions on the front end side. Each of the engaging plates 2a is provided with a groove 2b which is open downwardly. Flange-equipped rollers 2c are attached to both side portions on the back end side of the arrangement area 2 respectively. Each of the rollers 2c is rollably engaged with the second guide groove 1b of each of the side plates 1. Further, the slide member 3 is formed to be slightly wider than the width of the arrangement area 2, and the slide member 3 is arranged under or below the arrangement area 2. Guide projections, which extend in the front-back direction, are provided on both side surfaces of the slide member 3 respectively. Rollers 3b are attached on the back end side thereof. Each of the guide projections and each of the rollers 3b are engaged with the first guide groove 1a of each of the side plates 1. The guide projection is supported by the roller 1c of the side plate 1. The roller 3b of the slide member 3 rolls in the first guide groove 1a. Further, pins 3a are provided respectively in order to support the arrangement area 2 on the front end side, on both side portions on the front end side of the slide member 3. Each of the grooves 2b of the respective engaging plates 2a of the arrangement area 2 is engaged with each of the pins 3a. The arrangement area 2 is supported rotatably about the center of each of the pins 3a.

A linear motion actuator 4 is installed on the back surface side of the store shelf 10 in order to allow the arrangement area 2 to slide to the front of the store shelf 10. An output shaft 5 of the linear motion actuator 4 has a forward end thereof which is swingably connected to the side surface of the slide member 3 by the aid of a joint 6. Therefore, when the linear motion actuator 4 is operated, the output shaft 5 is displaced in the front-back direction of the store shelf 10. Accordingly, the arrangement area 2 can protrude from the inside to the outside of the store shelf 10 in cooperation with the slide member 3, or the arrangement area 2 can be accommodated in the inside of the store shelf 10. Then, the linear motion actuator 4 is electrically connected to the server 20. The linear motion actuator 4 is driven in accordance with an instruction from the server 20.

In the case of the store shelf 10 configured as described above, if the arrangement area 2 is stored or accommodated in the space between the respective side plates 1 as shown in FIG. 2, then the respective rollers 2c of the arrangement area 2 are positioned on the back end side of the second guide grooves 1b, i.e., at the inclined portions of the second guide grooves 1b, and thus the arrangement area 2 is retained so that the descending inclination is formed frontwardly. Subsequently, when the linear motion actuator 4 is driven, then the arrangement area 2 is allowed to slide frontward together with the slide member 3 as shown in the upper part of FIG. 3, and the respective rollers 2c of the arrangement area 2 move toward the front end side on the inclined portions of the second guide grooves 1b. Accordingly, the back end side of the arrangement area 2 is moved downwardly. When the respective rollers 2c of the arrangement area 2 arrive at the front end side of the second guide grooves 1b, the arrangement area 2 is in the horizontal state as shown in the lower part of FIG. 3.

As described above, according to the store shelf 10, when the arrangement area 2 and the slide member 3 are allowed to protrude frontwardly upon the replenishment with the product, then the arrangement area 2 is in the horizontal state, and the replenishment with the product can be performed extremely easily from the position disposed in front of the store shelf 10. In this case, the arrangement area 2 and the slide member 3 are moved in the horizontal direction. Therefore, the weight of the product does not act in the inclination direction of the arrangement area 2. It is possible to easily perform the frontward sliding movement of the arrangement area 2 and the slide member 3.

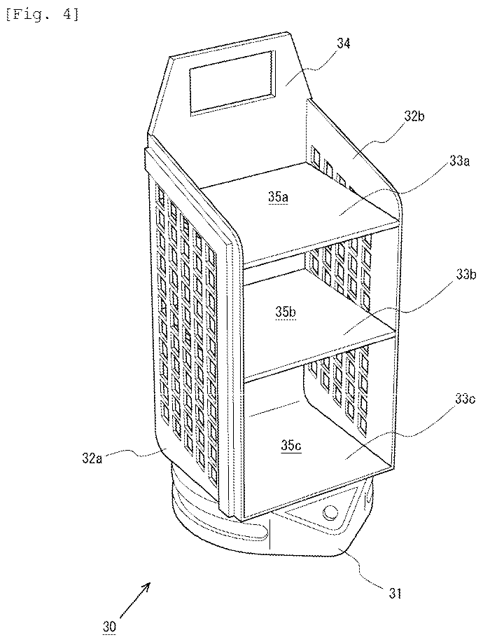

Next, an explanation will be made about schematic configuration of the conveying apparatus 30 on the basis of FIG. 4. The conveying apparatus 30 has a base unit 31 which is capable of performing autonomous traveling, and a main body unit 34 which is installed on the base unit 31. In the main body unit 34, accommodating spaces 35a to 35c, which are provided in order to accommodate the replenishing products, are formed by two side surface portions 32a and three partition walls 33a to 33c. Further, the main body unit 34 is provided on the base unit 31 by the aid of an unillustrated mechanism for changing the attitude or posture with respect to the base unit 31. Therefore, in the conveying apparatus 30, the main body unit 34 can be rotated or tilted (inclined) while maintaining a state in which the base unit 31 is not moved. Thus, it can be easy to make access to the accommodating spaces 35a to 35c from the outside of the conveying apparatus 30.

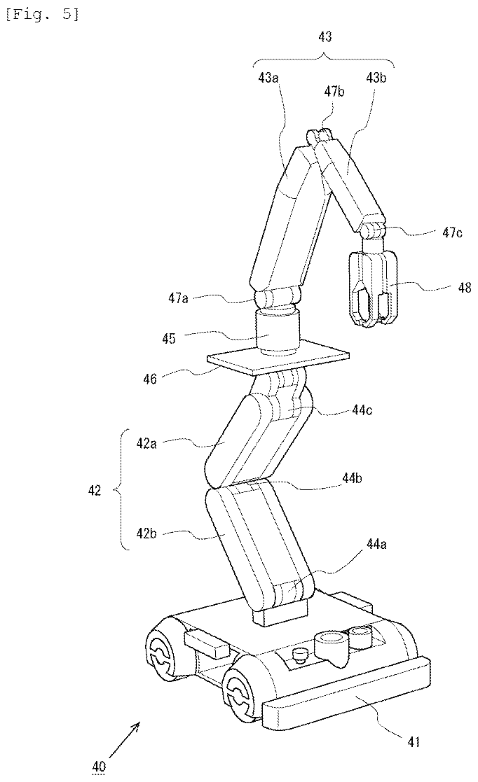

Next, an explanation will be made about schematic configuration of the replenishing apparatus 40 on the basis of FIG. 5. The replenishing apparatus 40 has a base unit 41 which is capable of performing autonomous traveling, and a robot arm unit which is installed on the base unit 41. Then, the robot arm unit includes a lower arm unit 42 disposed on the lower side and an upper arm unit 43 disposed on the upper side with a support plate 46 intervening therebetween. An end effector 48, which is provided to grip the product, is provided on the forward end side of the upper arm unit 43 with a joint 47c intervening therebetween.

The lower arm unit 42 has a first link portion 42b which is connected to the base unit 41 relatively rotatably by the aid of a joint 44a, a second link portion 42a which is connected to the first link portion 42b relatively rotatably by the aid of a joint 44b and which is connected to a support plate 46 relatively rotatably by the aid of a joint 44c, and a plurality of actuators (not shown) which drive and control the rotation of the respective joints. As for the respective joints, the directions of rotation thereof are designed in accordance with the gripping operation for gripping an object or target. For example, each of the joints 44a to 44c is configured so that the rotation can be effected about the pitch axis. Further, the driving amounts of the actuators for the joints 44a to 44c are controlled so that the support plate 46 has a desired height and the support plate 46 is retained horizontally. Note that the configuration of each of the joints is not limited to the mode as described above.

Further, the upper arm unit 43 has a third link portion 43a which is connected to the support plate 46 relatively rotatably by the aid of joints 45, 47a, a fourth link portion 43b which is connected to the third link portion 43a relatively rotatably by the aid of a joint 47b and which is connected to the end effector 48 relatively rotatably by the aid of a joint 47c, and a plurality of actuators (not shown) which drive and control the rotation of the respective joints. As for the respective joints, the directions of rotation thereof are designed in accordance with the gripping operation for gripping an object or target. For example, the joint 45 is configured to be rotatable about the yawing axis, each of the joints 47a, 47b is configured to be rotatable about the pitch axis, and the joint 47c is configured to be rotatable about the roll axis. Note that the configuration of each of the joints is not limited to the mode as described above.

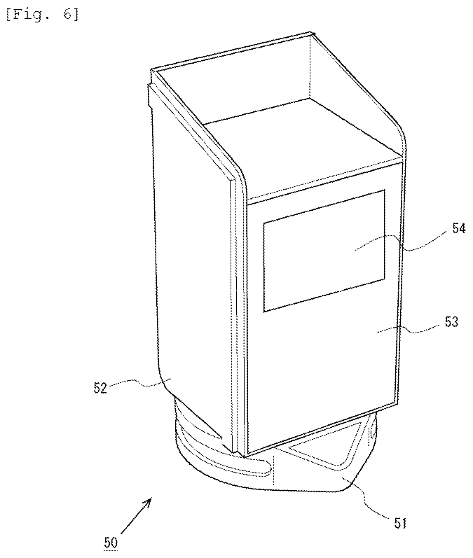

Next, an explanation will be made about schematic configuration of the guiding apparatus 50 on the basis of FIG. 6. The guiding apparatus 50 has a base unit 51 which is capable of performing autonomous traveling, and a main body unit 52 which is installed on the base unit 51. Further, a display 54, which is provided in order to perform a predetermined guiding action, is arranged on a front surface 53 of the main body unit 52. The predetermined guiding action is an action performed in order that the surroundings, especially users if the users are present in the store are guided to know the execution of the replenishing operation with the product performed by the replenishing apparatus 40. For example, it is displayed on the display 54 that the replenishing operation is being performed. Further, a speaker or the like may be provided on the front surface 53 to perform the guiding action with voice.

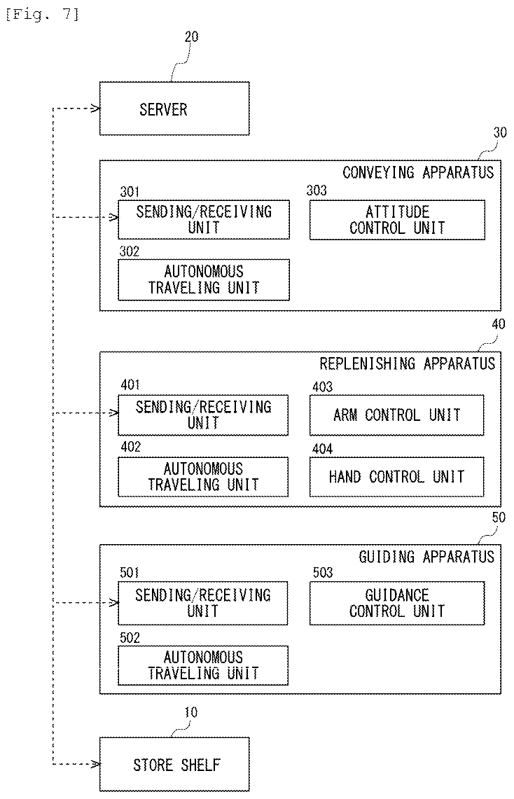

An explanation will now be made on the basis of FIG. 7 about the configuration of the product replenishment system of the embodiment of the present invention. The product replenishment system is formed by the server 20, the conveying apparatus 30, the replenishing apparatus 40, the guiding apparatus 50, and the store shelf 10. Each of the conveying apparatus 30, the replenishing apparatus 40, and the guiding apparatus 50 is also a computer substantially having an arithmetic processing unit and a memory, in the same manner as the server 20. A predetermined control program is executed in each of them, and thus functional units shown in FIG. 7 are formed.

The conveying apparatus 30 has a sending/receiving unit 301, an autonomous traveling unit 302, and an attitude control unit 303. The sending/receiving unit 301 is a functional unit which sends/receives the information with respect to other apparatuses in the product replenishment system. The conveying apparatus 30 can mutually send/receive the information with respect to the replenishing apparatus 40 and the guiding apparatus 50 as well without being limited to only the server 20. Further, the autonomous traveling unit 302 is a functional unit which is provided in order that the conveying apparatus 30 autonomously travels. The conveying apparatus 30 is installed, for example, with a GPS apparatus, a camera and various sensors (for example, distance measuring sensors) for grasping the presence of any obstacle in the surroundings. The autonomous traveling is realized by the autonomous traveling unit 302 by utilizing the information supplied from the sensors and the like. Note that when the autonomous traveling is performed by the autonomous traveling unit 302, it is also allowable to utilize the information supplied from the outside as obtained via the sending/receiving unit 301. The attitude control unit 303 is a functional unit which controls the attitude of the main body unit 34 with respect to the base unit 31. As described above, when the replenishing operation is performed by the replenishing apparatus 40, the attitude may be controlled so that the replenishing product is easily accessed.

The replenishing apparatus 40 has a sending/receiving unit 401, an autonomous traveling unit 402, an arm control unit 403, and a hand control unit 404. As for the sending/receiving unit 401 and the autonomous traveling unit 402, the functions have the same qualities as those of the sending/receiving unit 301 and the autonomous traveling unit 302 of the conveying apparatus 30. Therefore, any detailed explanation thereof is omitted. The arm control unit 403 controls the lower arm unit 42 and the upper arm unit 43 to perform the control so that the position of the end effector 48 is disposed at a desired position, for example, a position of the store shelf 10 which is to be replenished with the replenishing product. In this procedure, the arm control unit 403 controls the lower arm unit 42 so that the support plate 46 is approximately horizontal. Thus, the attitude of the upper arm unit 43 can be always maintained in a stable state, and it is possible to secure the safety upon the replenishment with the product by the replenishing apparatus 40. Then, the hand control unit 404 is a functional unit which controls the gripping action for gripping the replenishing product by the end effector 48. In the embodiment of the present invention, the end effector 48 is not limited to one having the specified structure, provided that the end effector 48 has any mechanism suitable for gripping the replenishing product. Therefore, the hand control unit 404 is also formed depending on the structure of the adopted end effector 48.

The guiding apparatus 50 has a sending/receiving unit 501, an autonomous traveling unit 502, and a guidance control unit 503. As for the sending/receiving unit 501 and the autonomous traveling unit 502, the functions have the same qualities as those of the sending/receiving unit 301 and the autonomous traveling unit 302 of the conveying apparatus 30. Therefore, any detailed explanation thereof is omitted. The guidance control unit 503 is a functional unit which controls the guiding action performed by the guiding apparatus 50, i.e., the display of guidance letters or the like on the display 54.

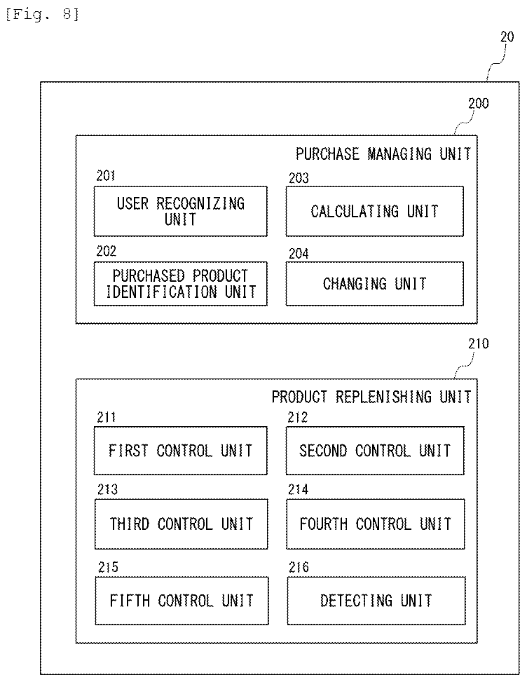

The conveying apparatus 30, the replenishing apparatus 40, and the guiding apparatus 50, which have the functional units as described above, cooperate with the server 20 and the store shelf 10, and thus the product replenishment system is formed. Next, an explanation will be made on the basis of FIG. 8 about functional units formed in the server 20. The server 20 is formed with roughly classified two functional units, i.e., a purchase managing unit 200 and a product replenishing unit 210. The purchase managing unit 200 is a functional unit which performs a management process in relation to the purchase of the product by the user. Further, the product replenishing unit 210 is a functional unit which performs a process relevant to the replenishment of the store shelf 10 with the replenishing product. The functional unit cooperates with the conveying apparatus 30, the replenishing apparatus 40, the guiding apparatus 50, and the store shelf 10, and thus the product replenishment system is formed. The purchase managing unit 200 and the product replenishing unit 210 will be explained below respectively.

The purchase managing unit 200 has a user recognizing unit 201, a purchased product identification unit 202, a calculating unit 203, and a changing unit (accounting unit) 204. The user recognizing unit 201 is a functional unit which recognizes the room entrance and the room exit of the user with respect to the store and which performs a recognition process for recognizing the action pattern of the user in the store. As for the room entrance of the user, the user identification information is transmitted from the user terminal 60 to the room entrance identification apparatus 13 in accordance with a predetermined program installed in the user terminal 60, and the identification information is received by the user recognizing unit 201. The user recognizing unit 201 judges whether or not the user is registered for the utilization in advance on the basis of the received identification information, and the user recognizing unit 201 performs the recognition process for recognizing the user. Further, similarly, as for the room exit of the user, the user identification information is transmitted from the user terminal 60 to the room exit identification apparatus 18, and the user recognizing unit 201 performs a recognition process for recognizing the user who exits the room. Further, the action of the user in the store is always photographed or subjected to the image pickup by the recording camera 8. The image pickup information is sent to the user recognizing unit 201. The user recognizing unit 201 recognizes the action pattern of each of the users on the basis of the received image pickup information. For example, the user recognizing unit 201 extracts, from the image pickup information, the action pattern including, for example, the walking of the user through the passage for movement, the touching of the user with the product, and the pickup of the product by the user with the intension to purchase the product. Further, when a proximity sensor (not shown), which makes it possible to confirm the presence of the product on the store shelf 10, is installed, then the user recognizing unit 201 acquires the information of the proximity sensor, and thus it is possible to recognize the action pattern of the user together with the image pickup information described above.

The purchased product identification unit 202 is a functional unit which identifies the product picked up by the user with the intension to purchase the product. If it is judged by the user recognizing unit 201 that the user takes the action pattern to pickup the product, the purchased product identification unit 202 identifies the product as the object or target. Specifically, the product, which is the object or target of the purchase, is identified on the basis of the information of, for example, the store shelf 10 from which the user picked up the product on the basis of the image pickup information obtained by the recording camera 8 and/or the proximity sensor installed for the store shelf 10.

The calculating unit 203 is a functional unit which calculates the purchase amount of the purchased product or products identified by the purchased product identification unit 202. The server 20 has a database in which prices of the respective products are summarized or organized. The calculating unit 203 calculates the purchase amount by making access to the database. Then, the changing unit 204 is a functional unit which performs the accounting process (charging process) for charging the user with the purchase amount of the purchased product or products when the user exits the store. For example, if the room exit action of the user is recognized by the user recognizing unit 201, such a process is performed that the purchase amount, which has been calculated by the calculating unit 203 until that time, is paid, for example, from a bank account of the user having been registered in advance.

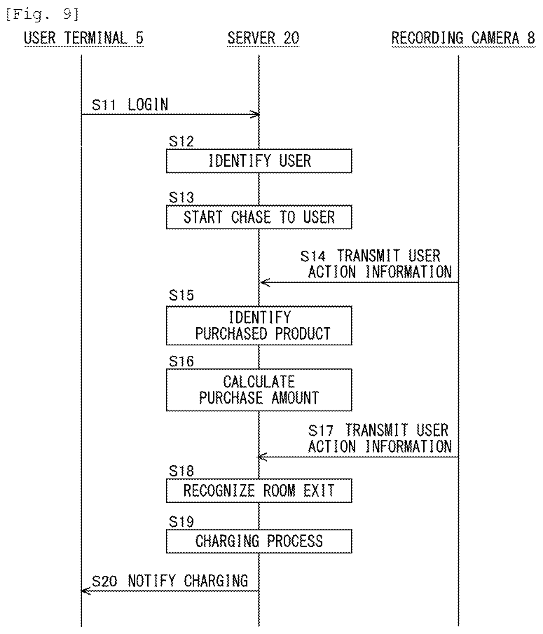

An explanation will now be made on the basis of a flow chart shown in FIG. 9 about an example of the process relevant to the purchase of the product by the user as performed by the purchase managing unit 200. The login of the user is executed (process of S11) by allowing the user terminal 60 to make access to the room entrance identification apparatus 13. After that, a recognition process for recognizing the user is performed by the user recognizing unit 201 (process of S12). Then, the chase to the action of the user is started by the user recognizing unit 201 on the basis of the image pickup information acquired from the recording camera 8 (process of S13). Note that the chase to the action of the user, which is performed by the user recognizing unit 201, is continued as long as the user exists in the store. Further, as described above, the recording camera 8 always transmits the image pickup information to the server 20. However, in the flow chart shown in FIG. 9, the process is expressed such that the image pickup information is transmitted from the recording camera 8 only when the information is especially referred to.

Then, if the image pickup information (action information of the user) is transmitted from the recording camera 8 to the server 20 in S14, and the purchase action performed by the user is recognized by the user recognizing unit 201, then the purchased product, which relates to the purchase action, is identified by the purchased product identification unit 202 (process of S15). Every time when the purchased product is identified, the purchase amount is calculated by the calculating unit 203 (process of S16). Further, if the image pickup information (action information of the user) is transmitted from the recording camera 8 to the server 20 in S17, and the room exit action performed by the user is recognized by the user recognizing unit 201 (process of S18), then the accounting process is performed to bill the user for the purchase amount having been calculated by the calculating unit 203 until that time (process of S19). After that, the server 20 informs the user terminal 60 of the fact that the accounting has been performed (process of S20).

As described above, owing to the process performed by the purchase managing unit 200, the user can purchase the product while arranging substantially no clerk in the store. On the other hand, if the user purchases the product or products, the number of the products is of course decreased on the store shelf 10. Therefore, it is necessary that the store shelf 10 should be timely replenished with the product or products. In view of the above, the process is performed by the product replenishing unit 210 in order that the replenishment with the product is realized without requiring the arrangement of the clerk as less as possible in relation to the replenishment with the product as well.

In this case, the product replenishing unit 210 has a first control unit 211, a second control unit 212, a third control unit 213, a fourth control unit 214, a fifth control unit 215, and a detecting unit 216. At first, the detecting unit 216 is a functional unit which detects the fulfilled state of the product arranged on the store shelf 10. The detection is performed by the detecting unit 216 for every type of the products arranged on the store shelf 10 respectively. Specifically, the detecting unit 216 detects the degree of fulfillment of the product on each of the store shelves 10, in other words, the degree of the remaining product on each of the store shelves 10 on the basis of, for example, the detection information of the proximity sensor installed for each of the store shelves 10 and the information of the purchased product identified by the purchased product identification unit 202. Note that the detecting unit 216 always detects the fulfilled state of the product on each of the store shelves 10.

The first control unit 211 is a functional unit which issues the instruction to the conveying apparatus 30 so that the store shelf 10 as the replenishment object or target is replenished with the replenishing product from the rack 16 in the backyard 15 on the basis of the fulfilled state detected by the detecting unit 216. The conveying apparatus 30, which receives the instruction, follows the instruction to execute the movement from the present position to the backyard 15 and the movement from the backyard 15 to the store shelf 10, in accordance with the control of the autonomous traveling unit 302. In the next place, the second control unit 212 is a functional unit which issues the instruction to the replenishing apparatus 40 so that the replenishing apparatus 40 moves to the store shelf 10 as the replenishment object or target on the basis of the fulfilled state detected by the detecting unit 216. The replenishing apparatus 40, which receives the instruction, follows the instruction to execute the movement from the present position to the store shelf 10, in accordance with the control of the autonomous traveling unit 402.

Further, the third control unit 213 is a functional unit which issues the instruction to the store shelf 10 so that the arrangement area 2 of the store shelf 10 as the replenishment object or target is allowed to slide frontward. The instruction is delivered to the linear motion actuator 4 installed for the store shelf 10. The linear motion actuator 4, which receives the instruction, extends or stretches the output shaft 4 thereof frontwardly. Accordingly, as shown in FIG. 3, the arrangement area 2 slides to the front of the store shelf 10, and the replenishing apparatus 40 can access the arrangement area 2. In the next place, the fourth control unit 214 is a functional unit which permits the replenishing apparatus 40 to lift the replenishing product conveyed by the conveying apparatus 30 and replenish the arrangement area 2 slide frontward with the replenishing product. The replenishing apparatus 40, which receives the permission, executes the replenishing operation with the replenishing product by controlling the lower arm unit 42, the upper arm unit 43, and the end effector 48 by the arm control unit 403 and the hand control unit 404. In the next place, the fifth control unit 215 is a functional unit which issues the instruction to the guiding apparatus 50 so that the guiding apparatus 50 moves to the store shelf 10 as the replenishment object or target on the basis of the fulfilled state detected by the detecting unit 216. The guiding apparatus 50, which receives the instruction, follows the instruction to execute the movement from the present position to the store shelf 10 in accordance with the control of the autonomous traveling unit 502.

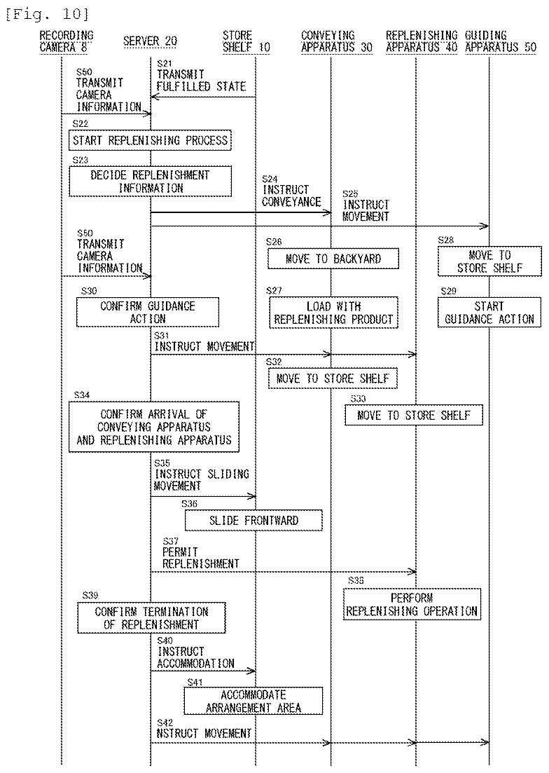

An explanation will now be made on the basis of a flow chart shown in FIG. 10 about an example of the process relevant to the replenishment with the product performed by the product replenishing unit 210. Note that as described above, the recording camera 8 always transmits the image pickup information to the server 20, and the server 20 always detects the fulfilled state in relation to the store shelf 10 by means of the detecting unit 216. However, in the flow chart shown in FIG. 10, the process is expressed such that the information is transmitted from the recording camera 8 and the store shelf 10 only when the information is especially referred to.

In S21, the information relevant to the fulfilled state is transmitted from the store shelf 10, and the fulfilled state is detected by the detecting unit 216 on the side of the server 20. Further, in S50, the image pickup information is transmitted from the recording camera 8, and the image pickup information is delivered to the purchase managing unit 200 and the product replenishing unit 210 on the side of the server 20. In this procedure, it is judged whether or not the store shelf 10 is to be replenished with the product on the basis of the information relevant to the fulfilled state as sent from the store shelf 10. If it is judged that the replenishment is to be performed, the replenishing process is started (process of S22). As for the replenishing process, it is also allowable to start the replenishing process if the fulfillment ratio of the product on the store shelf 10 is lower than a predetermined ratio. Subsequently, in S23, the replenishment information, which is required for the replenishing process, is decided. Specifically, the replenishment information includes, for example, the product to be subjected to the replenishment (replenishing product) and the number thereof, and the position of the store shelf 10 as the replenishment object or target.

Subsequently, in S24, the conveyance instruction is transmitted together with the replenishment information from the first control unit 211 of the server 20 to the conveying apparatus 30. Note that the conveyance instruction is such an instruction that the conveying apparatus 30 is loaded with the replenishing product in the backyard 15 to convey the product to the store shelf 10 as the replenishment object or target. However, when the conveying apparatus 30 is loaded in the backyard 15, the instruction requests the conveying apparatus 30 to wait in the backyard 15 until the movement instruction of S31 is received as described later on. If the instruction is received, then the conveying apparatus 30 is moved from the present position to the backyard 15 (process of S26), and the conveying apparatus 30 is loaded with the replenishing product from the rack 16 in the backyard 15 (process of S27). As for the loading with the replenishing product, it is possible to utilize any known loading technique (for example, a robot or the like for the palletizing).

Further, in S25, the movement instruction is transmitted together with the replenishment information to the guiding apparatus 50 by the fifth control unit 215 of the server 20. If the instruction is received, then the guiding apparatus 50 is moved from the present position to the store shelf 10 as the replenishment object or target (process of S28), and the guiding apparatus 50 starts the guiding action when the guiding apparatus 50 arrives at the store shelf 10 (process of S29). Specifically, the guidance display is started on the display 54 in the vicinity of the store shelf 10 while avoiding the front of the store shelf 10. The reason, whey the guiding apparatus 50 avoids the front of the store shelf 10 as described above, is that the arrangement area 2 of the store shelf 10 slides frontward in accordance with the process of S36 described later on. When the guiding action is started by the guiding apparatus 50, then the execution of the replenishing operation for the product is well-known to the user who is present in the store, and the safety of the operation is secured.

Then, the server 20 confirms, in S30, that the guiding apparatus 50 arrives at the store shelf 10 and that the guiding apparatus 50 starts the guiding action at that position. Specifically, the server 20 may confirm the start of the guiding action on the basis of the image pickup information of the recording camera 8. Alternatively, the confirmation can be also performed by transmitting the information that the guiding action is started, from the guiding apparatus 50 to the server 20. Then, after performing the confirmation of the guiding action as described above, the instruction is issued in S31 to the conveying apparatus 30 which waits in the backyard 15 so that the conveying apparatus 30 moves to the store shelf 10, by means of the first control unit 211 of the server 20. Further, the instruction is issued to the replenishing apparatus 40 so that the replenishing apparatus 40 moves to the store shelf 10, by means of the second control unit 212. The conveying apparatus 30 and the replenishing apparatus 40, which receive the respective instructions, move to the store shelf 10 (processes of S32 and S33). In particular, assuming such a state that the arrangement area 2 of the store shelf 10 slides frontwardly in accordance with the process of S36 described later on, the replenishing apparatus 40 arrives at the store shelf 10 so that the replenishing apparatus 40 is positioned on the side of the arrangement area 2 allowed to slide. The conveying apparatus 30 arrives at the store shelf 10 so that the conveying apparatus 30 is positioned within a range in which the replenishing apparatus 40 can access the replenishing product with which the conveying apparatus 30 is loaded.

Then, in S34, the server 20 confirms that both of the conveying apparatus 30 and the replenishing apparatus 40 arrive at the store shelf 10. Specifically, if it is judged on the basis of the image pickup information of the recording camera 8 that the conveying apparatus 30 and the replenishing apparatus 40 are positioned within a predetermined range (for example, within a radius of 2 m) from the store shelf as the replenishment object or target, it is possible to confirm the arrival of the both. Alternatively, in another method, the server 20 can also confirm the confirmation by transmitting, to the server 20, the information that the conveying apparatus 30 and the replenishing apparatus 40 arrive at the store shelf 10, from the conveying apparatus 30 and the replenishing apparatus 40 respectively. Then, after performing the confirmation of the arrival as described above, the instruction is issued to the store shelf 10 in S35 by the third control unit 213 of the server 20 so that the arrangement area 2 is allowed to slide to the front of the store shelf 10. If the instruction is received, then the store shelf 10 operates the linear motion actuator 4 to extend or stretch the output shaft 5 thereof frontward, and the arrangement area 2 is allowed to slide frontwardly (process of S36). In this situation, the guiding action by the guiding apparatus 50 has been already started. Further, the conveying apparatus 30, the replenishing apparatus 40, and the guiding apparatus 50 are arranged while avoiding the position disposed in front of the store shelf 10. Therefore, the arrangement area 2 can be allowed to slide frontward extremely safely.

Then, if the sliding process for the arrangement area 2 is completed on the store shelf 10, the permission is issued to the replenishing apparatus 40 in S37 to start the replenishing operation with the replenishing product, by the fourth control unit 214 of the server 20. If the permission is received, the replenishing apparatus 40 starts the replenishing operation with the replenishing product (process of S38). The replenishing apparatus 40 replenishes, with the product, behind any other product remaining in the arrangement area 2 allowed to slide. The arrangement area 2 is allowed to slide frontward, and the replenishing apparatus 4 is positioned on the side of the arrangement area 2. Therefore, the replenishment with the replenishing product as described above can be performed extremely easily. In S39, the server 20 confirms the termination of the replenishing operation having been performed by the replenishing apparatus 40. Specifically, the termination may be confirmed on the basis of the image pickup information of the recording camera 8. In another method, the server 20 can also perform the confirmation by transmitting, to the server 20, the information that the replenishing operation is terminated, by the replenishing apparatus 40.

Then, after performing the confirmation of the termination of the replenishing operation as described above, the instruction is issued in S40 by the third control unit 213 of the server 20 to the store shelf 10 so that the arrangement area 2 thereof is accommodated into the inside of the store shelf 10. If the instruction is received, then the store shelf 10 operates the linear motion actuator 4 to retract or return the output shaft 5, and the arrangement area 2 is allowed to slide into the store shelf 10 (process of S41). If the arrangement area 2 is accommodated, the server 20 issues, in S42, the instructions to the conveying apparatus 30, the replenishing apparatus 40, and the guiding apparatus 50 respectively so that they move to predetermined positions. For example, the server 20 may issue the instructions to the respective apparatuses so that they return to the inside of the backyard 15. Alternatively, the server 20 may issue the instructions so that the respective apparatuses autonomously move in the store. In this situation, the server 20 issues the instruction to the guiding apparatus 50 which has continued the guiding action until that time so that the guiding action is to be terminated.

As described above, in the case of the product replenishment system of the embodiment, if the number of the products arranged on the store shelf 10 is decreased as a result of the purchase by the user, it is possible to realize the replenishment with the products substantially automatically. Further, upon the replenishment with the product, the replenishing operation is well-known to the surroundings by the guiding apparatus, and thus it is possible to secure the high safety of the user. Note that in the embodiment described above, the replenishing process is started after judging whether or not the replenishing process is required on the basis of the information relevant to the fulfilled state supplied from the store shelf 10 and/or the image pickup information supplied from the recording camera 8. However, in order to further enhance the safety of the user, the replenishing process may be started after waiting for the timing at which it is judged that the replenishing process is required and the number of the users existing in the store is less than a predetermined number or the timing at which the user disappears in the store. Further, when the replenishing operation is executed by the replenishing apparatus 40, if the server 20 detects the approach of the user to the store shelf 10 on the basis of the image pickup information of the recording camera 8, then an instruction is issued from the server 20 to the guiding apparatus 50, and the replenishing operation is made well-known to the user in a more conspicuous form (for example, in a form in which the display or indication on the display 54 is flashed and/or the volume of the speaker is increased). Further, if the server 20 detects that the user approaches the store shelf 10 extremely closely, the server 20 may issue an instruction to the replenishing apparatus 4 to stop the replenishing operation.

Note that in the product replenishment system of the embodiment of the present invention, the conveying apparatus 30, the replenishing apparatus 40, and the guiding apparatus 50 are configured as the independent apparatuses respectively. However, in place of such a mode, one apparatus may be configured to exhibit a plurality of functions, i.e., at least two functions of the conveying function, the replenishing function, and the guiding function. For example, the product replenishment system may be formed so that one apparatus exhibits the conveying function as the conveying apparatus and the guiding function as the guiding apparatus. In other words, an apparatus, which is configured by integrating the conveying apparatus and the guiding apparatus into one unit, may be included in the product replenishment system.

### Description of the Reference Signs

8: recording camera, 10: store shelf, 20: server, 30: conveying apparatus, 40: replenishing apparatus, 50: guiding apparatus.

1. A controller for product replenishment for controlling a product replenishment system including:
a store shelf on which one product or a plurality of products can be arranged;
a conveying apparatus configured to be autonomously movable and to convey a product for replenishing the store shelf therewith from a storage space for storing the product therein to the store shelf; and
a replenishing apparatus configured to be autonomously movable and to lift the product conveyed by the conveying apparatus and to replenish the store shelf with the product, the controller comprising:
a detecting unit configured to detect a fulfilled state of the product on the store shelf;
a first control unit configured to issue, to the conveying apparatus, an instruction for conveying the product required to fulfill the store shelf from the storage space to the store shelf on the basis of the fulfilled state detected by the detecting unit;
a second control unit configured to issue, to the replenishing apparatus, an instruction for moving to the store shelf on the basis of the fulfilled state detected by the detecting unit;
a third control unit configured to issue, to the store shelf, an instruction for allowing an arrangement area to slide from inside of the store shelf to the front of the store shelf so that the replenishing apparatus can access the arrangement area in which the product is arranged on the store shelf; and
a fourth control unit configured to permit the replenishing apparatus to lift the product conveyed by the conveying apparatus and replenish the arrangement area slide frontward with the product.

2. The controller for product replenishment according to claim 1, wherein the third control unit issues, to the store shelf, the instruction for allowing the arrangement area to slide when both of the replenishing apparatus and the conveying apparatus arrives at positions disposed within a predetermined range from the store shelf.

3. The controller for product replenishment according to claim 1, wherein the replenishing apparatus replenishes, with the product, behind any other product remaining in the arrangement area, in accordance with the permission of the fourth control unit.

4. The controller for product replenishment according to claim 1, wherein the replenishing apparatus includes:
a movable member configured to be autonomously movable;
an arm unit configured to be provided on the movable member and to have a plurality of arms connected to one another at respective joints so that the plurality of arms are relatively displaceable with respect to one another; and
a hand unit configured to be provided on a forward end side of the arm unit and to be capable of gripping the product; and
the second control unit configured to issue the instruction to the replenishing apparatus so that the replenishing apparatus is positioned on a side of the arrangement area when the arrangement area is allowed to slide to the front of the store shelf.

5. The controller for product replenishment according to claim 1, wherein:
the product replenishment system further includes a guiding apparatus which is autonomously movable and which is configured to be capable of executing a predetermined guiding action for surroundings;
the controller for product replenishment further comprises a fifth control unit which issues, to the guiding apparatus, an instruction for moving to the store shelf on the basis of the fulfilled state detected by the detecting unit; and
the guiding apparatus starts the predetermined guiding action before starting the sliding of the arrangement area of the store shelf if the guiding apparatus waives at the store shelf in accordance with the instruction issued from the fifth control unit, and the guiding apparatus continues the predetermined guiding action until the arrangement area allowed to slide is accommodated in the store shelf.

6. A product replenishment system comprising:
a store shelf on which one product or a plurality of products can be arranged;
a conveying apparatus configured to be autonomously movable and to convey a product for replenishing the store shelf therewith from a storage space for storing the product therein to the store shelf;
a replenishing apparatus configured to be autonomously movable and to lift the product conveyed by the conveying apparatus and to replenish the store shelf with the product; and
a controller configured to control the conveying apparatus and the replenishing apparatus in order to replenish the store shelf with the product, wherein:
the controller detects a fulfilled state of the product on the store shelf;
the conveying apparatus conveys the product required to fulfill the store shelf from the storage space to the store shelf on the basis of the detected fulfilled state;
the replenishing apparatus moves to the store shelf on the basis of the detected fulfilled state;
the store shelf allows an arrangement area to slide frontwardly with respect to the store shelf from inside of the store shelf so that the replenishing apparatus can access the arrangement area in which the product is arranged on the store shelf; and
the replenishing apparatus lifts the product conveyed by the conveying apparatus and replenishes the arrangement area slide frontward with the product.
